(19) United States
(12) Patent Application Publication
(10) Pub. No.: US 2002/0006873 A1
(43) Pub. Date: Jan. 17, 2002

(54) Systems for controlling plant and flower moisture transpiration rates

(76) Inventors: Mark William Hamersky, Hamilton, OH (US); Steven Daryl Smith, Fairfield, OH (US)

Correspondence Address: THE PROCTER & GAMBLE COMPANY, PATENT DIVISION, MIAMI VALLEY LABORATORIES, P.O. BOX 538707, CINCINNATI, OH, 45253-8707, US

(21) Appl. No.: 09/759,864

(22) Filed: Jan. 12, 2001

Related U.S. Application Data
(60) Provisional application No. 60/176,089, filed on Jan. 14, 2000.

(51) Int. Cl. A01N 43/80; A01N 25/10

(52) U.S. Cl. 504/269; 504/361

(57) ABSTRACT

The present invention relates to a system for controlling plant and flower moisture transpiration and thereby extending the period of time in which cut flowers can be displayed before senescence produces a flower which has exceeded its aesthetic value. The systems of the present invention comprise:

a) a first component in the form of a solution, said solution applied to the surface of a plant or flower exposed to air, said first component comprising:

i) a polymer having a water vapor transfer rate of less than 10 g-mm/m²-day and a glass transition temperature, T_{g}, greater than about 30° C.;

ii) the balance carriers and adjunct ingredients;

wherein said polymer is in the form of a microemulsion having a particle size less than 400 nanometers; and

b) a second component comprising:

i) a source of energy for the plant or flower being treated;

ii) an antimicrobial;

wherein said second component is dissolved in water to form a solution and into which solution is placed the plant or flower to be preserved.

This Application claims priority to U.S. Provisional Patent Application Serial No. 60/176,89 filed Jan. 14, 2000.

### FIELD OF THE INVENTION

The present invention relates to a system for controlling plant and flower moisture transpiration rates and thereby providing a system for extending the time in which plants and cut flowers can be utilized in aesthetic displays or floral arrangements.

### BACKGROUND OF THE INVENTION

Flowers have been inextricably linked to human culture since antiquity. Flowers have come to represent various aspects of life and to represent various facets of the human condition. As symbols of our society they speak directly. Flowers are never out of place regardless of the circumstances, inter alia, births, funerals, weddings, memorials.

Humans have cultivated and propagated flowers solely for their aesthetic value since most flowers are inedible. Incunabula describe various techniques for cutting and preserving flowers, inter alia, oriental flower varnishing, dipping blossoms into waxes or wax-like solutions. Contemporary practices include fashioning artificial flowers and blossoms from synthetic material, most notably polymers. However, all of these methods for preserving flowers, or attempts at flower imitation, fails to reproduce or replace the freshness of newly cut flowers.

The prior art has attempted to provide methods of preserving cut flowers in a fresh state, but the means are inadequate to provide flowers in a nearly original state for an enhanced period of time, for example, two to five times the expected period of use.

There is, therefore, a long felt need to provide the consumer or the grower of flowers which are to be cut and displayed for aesthetic purposes, with a system with significantly extends the duration in which the cut flowers maintain their original appearance.

### SUMMARY OF THE INVENTION

The present invention meets the aforementioned needs in that it has been surprisingly discovered that cut flowers can be preserved in a nearly original state for an extended period of time, in fact, in some instances a period which eclipses their aesthetic utility. It has been surprisingly discovered that by creating a “post-harvest viability equilibrium” flowers can be cut and displayed without the pejorative effects of natural demise (senescence), inter alia, wilting (epinasty) or loss of petals, browning or discoloration of flower parts. This post-harvest viability equilibrium can be suitably established by controlling the two aspects of the flower moisture transpiration cycle; moisture uptake and moisture transpiration rate.

Flowers are ubiquitous in that they can adapt to environmental or ecological stresses. For example, during times of drought or other circumstances of water deprivation, flowers regulate their growth to attenuate the effects which this moisture deprivation stress might have on their viability. This ability to self regulate their growth cycle ameliorates many of the pejorative consequences of water deprivation on flower survival. Once flowers are cut during harvesting, the natural regulatory systems, inter alia, respiration, water regulation, are abated. It has been surprisingly discovered that an artificial level of viability can be re-established by a system which controls the plant water intake/evaporation cycle. Although insufficient to induce or sustain reproductive viability, i.e. the production of pollen, seeds, etc., this system, nevertheless, maintains cut flowers in their natural condition for extended periods of time without the induction of discoloration, wilting, and petal loss.

The first aspect of the present invention relates to a system for controlling plant and flower moisture transpiration, said system comprising:

a) a first component in the form of a solution, said solution applied to the surface of a plant or flower exposed to air, said first component comprising:

i) a polymer having a water vapor transfer rate of less than 10 g-mm/m²-day and a glass transition temperature, T_{g}, greater than about 30° C.;

ii) the balance carriers and adjunct ingredients; and

b) a second component comprising:

i) a source of energy for the plant or flower being treated;

ii) a water clarification agent;

wherein said second component is dissolved in water to form a solution and into which solution is placed the plant or flower to be preserved.

The present invention also relates to a system wherein said first component comprises a polymer solution in the form of a microemulsion having a particle size less than 400 nanometers.

The present invention further relates to systems which can be adjusted by the formulator to meet certain use criteria, inter alia, preservation of cut flowers wherein either the first component or the second component is adjusted in a timely manner or wherein one or both components are applied only in a single instance or by way of a limited schedule.

Another aspect of the present invention is a means for selecting the elements which comprise the components of the present invention. For example, selection of which polymers are suitable for use in providing the benefits of the present invention.

These and other objects, features, and advantages will become apparent to those of ordinary skill in the art from a reading of the following detailed description and the appended claims. All percentages, ratios and proportions herein are by weight, unless otherwise specified. All temperatures are in degrees Celsius (° C.) unless otherwise specified. All documents cited are in relevant part, incorporated herein by reference.

### DETAILED DESCRIPTION OF THE INVENTION

The present invention relates to a system for controlling plant and flower moisture transpiration rates and thereby providing a system for extending the time in which plants and cut flowers can be utilized in aesthetic displays or floral arrangements. The present invention is achieved by controlling the intake of water and nutrients by a cut flower. The first component of the systems of the present invention provide a control over the loss of water by the plant through transpiration. The second component of the systems of the present invention provide a source of energy and water to the cut flower while controlling the growth of microbes and the calcium ion flux produced by the plant.

Without wishing to be limited by theory it has been found that control of the evaporation of water from cut flowers contributes to the enhanced duration with which flowers appear in their pre-harvested state. It has also been surprisingly discovered that a certain class of anti-microbial will abate the growth of microbes which serve to diminish the viability of cut flowers. However, prior art antimicrobials, inter alia, 8-hydroxy quinoline citrate actually enhances the growth of microorganisms after an initial diminution of their level. The pejorative consequences of microorganism growth in the display water (i.e. vase water) is not solely related to the aesthetics of the solution into which the flowers are placed, for example, milky appearance, formation of sediments, but instead the microorganisms occlude the xylem of the flower stem thereby attenuating the uptake of water and nutrients.

It has also been surprisingly discovered that once a post-harvest viability equilibrium has been established by providing a first component which regulates water transpiration from the non-immersed plant surface and a second component which provides a source of energy and preferably a means for attenuating microbial growth, a cut flower begins to establish an equilibrium concentration of calcium ions between the plant cell and the interstitial water. It is necessary to regulate this equilibrium and this can be accomplished by the presence of a water clarification agent. Therefore, depending upon the composition of the source water used to make up the solution of the second component, the amount of calcium sequestration will vary as an element of the second component.

For the purposes of the present invention the term “aesthetic utility” is defined herein as “the duration in which a flower retains its aesthetic appeal”. The end of aesthetic appeal may differ between species of plant or flower, however, non-limiting examples of a property which may contribute wholly or severally to a loss of aesthetic appeal include browning of petals, loss of petals, drooping or down turn of blossoms, wilting, and shrinkage of plant mass together with collapse of plant tissue. In some instances, one manifestation of senescence may abate the usefulness of the flower, for example, the “browning” of petals may preclude the further use of a flower regardless of the lack of other conditions which tend to detract from the aesthetic quality of the cut flower.

The following is a detailed description of the elements which comprise the present invention.

### Moisture Transpiration Control Systems

First Component

The first component of the moisture transpiration control systems of the present invention is a solution which is applied to the surface of a plant or flower which would not normally be immersed into a solution which contains the second component of the present invention. The first component solution can be delivered to the air exposed surface of the flower or plant by any suitable means. Non-limiting examples of delivery of the first component include, spraying by means of aerosol, or pump, direct immersion, and variations which combine elements of immersion and spraying. The elements which comprise the first component, in selected embodiments or utilization of the present invention, may be added in a sequence. For example, for certain plant morphologies, the first component may be divided into a pre-treatment component and a polymer comprising component. The pre-treatment component may comprise a carrier which wets the surface of the plant or flower such that the polymer component is uniformly applied. In other sequential embodiments, a surface modifying material, inter alia, surfactant, may be first applied to facilitate an even dispersion of the polymeric element. However, surfactants and other optional ingredients can be directly combined with the polymeric material.

Polymer

The preferred polymers of the present invention have a water vapor transfer rate of less than 10 g-mm/m²-day, more preferably 5 g-mm/m²-day, most preferably 2 g-mm/m²-day. Suitable means for determining water vapor transmission rates of polymers is by ASTM E-96-66, Procedure E at 90% relative humidity and 100° F. for a 1 mm or 2 mm film, or TAPPI T 464 os-79 for a 2 mm film.

The preferred copolymers of the present invention further have a glass transition temperature, T_{g}, greater than about 30° C., more preferably greater than about 40° C., most preferably greater than about 60° C. The glass transition temperature, T_{g}, of a particular co-polymer can be approximated beforehand by the Fox formula (T. G. Fox, Bull. Am. Phys. Soc., vol. 1 123 (1956) included herein by reference):

$$\frac{1}{{T}_{Co}} = \frac{{W}_{1}}{{T}_{1}} + \frac{{W}_{2}}{{T}_{2}} + … \frac{{W}_{n}}{{T}_{n}}$$

wherein W₁ represents the weight portion of monomer 1, W₂ represents the weight portion of monomer 2, T₁ the glass transition temperature of the polymerized monomer 1 in ° K, T₂ the glass transition temperature of the polymerized monomer 2 in ° K, T_{co}, the glass transition temperature of the copolymer in ° K.

The formulator can readily establish whether a copolymer will satisfy the requirements of vapor transfer rate and glass transition temperature as set forth herein above. A plot of the glass transition temperature, T_{g}, expressed in ° C. of the copolymer along the x axis (ordinate) versus the water vapor transfer rate expressed in g-mm/m²-day (measured or calculated) along the y axis (abscissa) preferably falls to the left of the line defined by the equation:

y=−0.068443×+10.

Points which fall to the right of said equation will have a permeability ineffective in establishing a suitable moisture barrier at a desirable glass transition temperature. Points which fall to the right of said equation may also produce films having no ability to form an aesthetically suitable surface. For example, too high of a glass transition temperature leads to hard and/or brittle films which may detract from the aesthetic qualities which are desirable. Preferably the water vapor transfer rate and glass transition temperature are adjusted such that the applied polymer produces a clear, colorless, translucent, and transparent film.

For the purposes of the present invention the term “polymer” is herein defined as “an oligomer, homo-polymer, co-polymer, or mixtures thereof which satisfy the herein described requirements for establishing a post-harvest viability equilibrium”. The post-harvest viability equilibrium is a moisture dependent steady state wherein nutrients are delivered to the plant or flower together with moisture in a suitable amount to attenuate the onset of plant senescence. The post-harvest viability equilibrium affords the plant or flowers with an artificial set of conditions wherein the plant or flower can adjust its metabolism in a manner which affords extended plant viability. To successfully establish the first aspect of this equilibrium, the water vapor transpiration rate, a material must be applied to the surface of the flower to control the loss of plant moisture.

In one embodiment of the present invention, it is preferred, for aesthetic purposes, that the polymers of the present invention when applied to the plant surface form a clear, colorless, translucent, and transparent membrane. Therefore, it is preferable that the polymers of the present invention when utilizing this embodiment are delivered via the carrier solution such that evaporation of the carrier solution leads to formation of a homogeneous polymer layer rather than “clumping” due to differential spreading along the flower surface.

In order to achieve the above desired embodiment resulting in clear, colorless, translucent, and transparent polymer films, the solution characteristics of the first component must be balanced in a manner wherein the polymer is not delivered in the form of a latex, but instead as a homogeneous solution, semi-dispersion, preferably as a microemulsion. When the first component of the present invention is delivered in the form of a microemulsion, said microemulsions will have a particle size of preferably less than 400 nanometers, more preferably less than about 200 nanometers, most preferably less than about 100 nanometers. However, the solution can comprise a polymer which is water soluble.

When present as part of a first component of the present invention, the polymer will comprise from about 0.01%, preferably from about 0.1%, more preferably from about 1%, most preferably from about 2% to about 20%, preferably to about 10%, more preferably to about 7%, most preferably to about 5% by weight, of the first component solution.

In another preferred embodiment of the present invention, relatively hydrophobic polymers are delivered to the surface of the cut flower by using an aqueous solution of said polymer wherein said solution further comprises a “temporary” solvent. A first component of the present invention directed to this embodiment comprises:

i) a polymer having a water vapor transfer rate of less than 10 g-mm/m²-day and a glass transition temperature, T_{g}, greater than about 30° C.;

ii) one or more temporary solvents, wherein said temporary solvent has a boiling point greater than 100° C.; and

iii) the balance carriers and adjunct ingredients.

Compositions which relate to this embodiment of the present invention are polymers which are in the form of a latex which is applied to the surface of the cut flower or plant. As the carrier, which is preferably a water/low molecular weight alcohol admixture, evaporates the temporary solvent becomes the milieu in which the polymer is dissolved. When the aqueous-based carrier has fully evaporated, there remains a thin film of polymer dissolved in the higher boiling temporary solvent. As the temporary solvent evaporates, the relatively hydrophobic polymer form a uniform layer upon the cut flower surface. Non-limiting examples of temporary solvents include isododecane, butylbenzyl phthalate, dibenzyl phthalate, dibenzyl toluene, diphenyloctyl phosphate, triphenyl phosphate, tricresyl phosphate, dibenzyl benzoate, diphenylether, dimethoxyethyl phthalate, diethoxyethyl phthalate, dibutoxyethyl phthalate, methylphthalylethyl glycollate, diethyleneglycol dibenzoate, dipropyleneglycol dibenzoate, acetyl tributyl citrate, dioctyl phthalate, dinonyl phthalate, didecyl phthalate, and mixtures thereof.

The polymers of the present invention can comprises any combination of monomers provided the requirements set forth hereinabove are met. The polymers may comprise the reaction products of mono-carboxylic acids and the esters, amides, and anhydrides thereof comprising one olefin moiety, non-limiting examples of which include acrylic acid, methacrylic acid, crotonic acid, and mixtures thereof; n-propyl methacrylate, n-butyl methacrylate, methyl methacrylate, n-butyl acrylate, 2-(N,N-dimethylamino)ethyl methacrylate, and mixtures thereof. The polymers of the present invention can also include polymers comprising the reaction products of mono-carboxylic acids and the esters, amides, and anhydrides thereof comprising one olefin moiety with polycarboxylic acids and the esters, amides, and anhydrides thereof comprising one olefin moiety. Non-limiting examples of suitable polycarboxylic acids are selected from the group consisting of oxalic acid, succinic acid, tartaric acid, itaconic acid, maleic acid, and mixtures thereof; and the esters, amides, and anhydrides thereof.

In one embodiment of the present invention, suitable polymers for the first component include the water-soluble and/or dispersible condensation products which can be obtained by the reaction of:

a) polyalkyleneimines and polyalkyleneimines grafted with ethyleneimines, and mixtures thereof; with

b) at least bifunctional halogen-free cross-linking agents, said agents selected from the group consisting of:

i) ethylene carbonate, propylene carbonate, urea, and mixtures thereof;

ii) mono-carboxylic acids comprising one olefin moiety inter alia acrylic acid, methacrylic acid, crotonic acid; and the esters, amides, and anhydrides thereof; polycarboxylic acids inter alia oxalic acid, succinic acid, tartaric acid, itaconic acid, maleic acid; and the esters, amides, and anhydrides thereof;

iii) reaction products of polyetherdiamines, alkylenediamines, polyalkylene-diamines, and mixtures thereof, with mono-carboxylic acids comprising one olefin moiety wherein the resulting polyamine comprises a functional units which is selected from the group consisting of at least two ethylenically unsaturated double bonds, carbonamide, carboxyl group, ester group, and mixtures thereof;

iv) at least two aziridine group-containing reaction products of dicarboxylic acid esters with ethyleneimine and mixtures of the cross-linking agents.

In a preferred embodiment of the present invention the polymers of the first component comprise the reaction product of:

a) mono-carboxylic acids comprising one olefin moiety inter alia acrylic acid, methacrylic acid, crotonic acid; and the esters, amides, and anhydrides thereof; polycarboxylic acids inter alia oxalic acid, succinic acid, tartaric acid, itaconic acid, maleic acid; and the esters, amides, and anhydrides thereof;

b) reaction products of polyetherdiamines, alkylenediamines, polyalkylene-diamines, and mixtures thereof, with mono-carboxylic acids comprising one olefin moiety wherein the resulting polyamine comprises a functional units which is selected from the group consisting of at least two ethylenically unsaturated double bonds, carbonamide, carboxyl group, ester group, and mixtures thereof;

wherein the number of protonated free carboxylic acid groups present after polymerization is reduced to from about 20% to about 60% of the groups present by the addition of a base, preferably sodium hydroxide.

A further preferred embodiment of the present invention relates to vinyl co-polymers which are formed from one or more “vinyl monomers” having the formula:

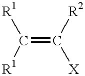

wherein each R¹ is independently hydrogen, C₁-C₁₂ alkyl, C₁-C₁₂ alkoxy, phenyl, substituted phenyl, benzyl, substituted benzyl, carbocyclic, heterocyclic, and mixtures thereof; R² is hydrogen, halogen, preferably chlorine or fluorine, C₁-C₁₂ alkyl, C₁-C₁₂ alkoxy, phenyl, substituted phenyl, benzyl, substituted benzyl, carbocyclic, heterocyclic, and mixtures thereof; X is hydrogen, hydroxyl, halogen, —(CH₂)ₘCH₂OH, —(CH₂)ₘCOR, —(CH₂)ₘ—CH₂OCOR′ wherein R is —OR′, —N(R′)₂, —(CH₂)ₙN(R″)₂, and mixtures thereof; each R′ is independently hydrogen, C₁-C₈ alkyl, C₂-C₈ hydroxyalkyl, —(CH₂)ₙN(R″)₂, and mixtures thereof; wherein R″ is independently hydrogen, C₁-C₄ alkyl, and mixtures thereof; the index m is from 0 to 6, the index n is from 2 to 6. Non-limiting examples of preferred vinyl monomers include, ethylene, propylene, butylene, styrene, vinyl alcohol, crotyl alcohol, acrylic acid, styrylacetic acid, methacrylic acid, crotonic acid, 3,3-dimethyl-acrylic acid, methyl acrylate, ethyl acrylate, n-propyl acrylate, isopropyl acrylate, butyl acrylate, methyl methacrylate, ethyl methacrylate, n-propyl methacrylate, isopropyl methacrylate, butyl methacrylate, methyl 3,3-dimethyl-acrylate, ethyl 3,3-dimethyl-acrylate, n-propyl 3,3-dimethyl-acrylate, isopropyl 3,3-dimethyl-acrylate, butyl 3,3-dimethyl-acrylate, acrylamide, N-methyl acrylamide, N,N-dimethyl acrylamide, N-(aminoethyl) methyl acrylamide, vinyl acetate, and mixtures thereof.

Another embodiment of the present invention relates to “crosslinkable vinyl monomers” having the formula:

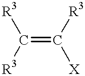

wherein X is the same as defined herein above; R³ is R¹, —(CH₂)ₘCH₂OH, —(CH₂)ₘCO₂R′, —(CH₂)ₘCH₂OCOR′ wherein each R′ is independently hydrogen, C₁-C₈ alkyl, and mixtures thereof; the index m is from 0 to 6. Non-limiting examples of “crosslinkable vinyl monomers” include maleic acid, fumaric acid, itaconic acid, citraconic acid, hydromuconic acid, vinyl acetate, and mixtures thereof.

When utilizing water-soluble vinyl co-polymers, the first component of the present invention will comprise from about 0.1%, preferably from about 1%, more preferably from about 2%, most preferably from about 2.5% to about 20%, preferably to about 10%, more preferably to about 7%, most preferably to about 5% by weight, of the composition. The vinyl co-polymer can be obtained for use in any form, for example, as a dispersion in the reaction (polymerization) solvent, or the polymer can be provided as a solid. Preferably some of carboxylic acid residues, acrylic acid, inter alia, which comprise the polymers of the present invention will be neutralized. From about 1%, more preferably from about 5%, more preferably from about 10% to about 100%, preferably to about 50%, more preferably to about 20%, most preferably to about 15% by weight, of the acid residues are neutralized. Suitable means for neutralization includes the use of bases, non-limiting examples of which include alkaline metal hydroxides, inter alia, sodium hydroxide, alkaline earth metal hydroxides, inter alia, calcium hydroxide, ammonia, and mixtures thereof. The degree of neutralization typically depends upon the selected monomers which comprise the polymer and which properties must be adjusted to insure the application of an homogeneous film which achieves the required glass transition temperatures and vapor transmission rates described herein.

It will be appreciated by the formulator that the water vapor transfer rates of the polymers will by related to the hydrophilicity of the polymers; the more hydrophilic a polymer the higher the water vapor transfer rate. It is preferred, for aesthetic purposes, that the polymers of the present invention when applied to the plant surface form a clear, colorless, translucent, and transparent membrane. Therefore, it is preferable that the polymers of the present invention when utilizing this embodiment are delivered via the carrier solution such that evaporation of the carrier solution leads to formation of a homogeneous polymer layer rather than “clumping” due to differential spreading along the flower surface. Preferred embodiments of the first component comprise a “non-browning” surfactant as described herein below to facilitate even application of the polymer film although use of a secondary solvent is also a preferred embodiment.

An example of a suitable copolymer comprises the reaction product obtained when polymerizing:

i) from about 20% to about 60% by weight, of methyl methacrylate;

ii) from about 20% to about 60% by weight, of butyl acrylate; and

iii) from about 0.5% to about 20% by weight, of acrylic acid.

A more preferred copolymer comprises the reaction product obtained when reacting:

i) from about 40% to about 50% by weight, of methyl methacrylate;

ii) from about 40% to about 50% by weight, of butyl acrylate; and

iii) from about 5% to about 15% by weight, of acrylic acid.

A further example of a copolymer suitable for use in the present invention comprises:

i) about 43% by weight, of methyl methacrylate;

ii) about 47% by weight, of butyl acrylate; and

iii) about 10% by weight, of acrylic acid.

Each of the above examples is more preferred in at least 5%, preferably 10% of the acrylic acid residues are neutralized with a suitable base.

Any suitable process can be used to form the compositions according to the present invention. However, it has been surprisingly discovered that the following process allows for the efficient formation of the polymeric solutions without phase separation. The process of the present invention comprises the steps of:

a) dissolving a solid polymeric material free from solvents in the alcohol portion of the carrier;

b) neutralizing acid residues to the desired level by adding dropwise an aqueous solution of base, preferably sodium hydroxide, more preferably 30% by weight sodium hydroxide;

c) adding at a rate of from 0.1% of the water which comprises the balance of the carrier to 10% of the water which comprises the balance of the carrier per minute; and

d) adding the surfactant.

The process of the present invention, starting from a latex, comprises the steps of:

a) adding to an aqueous latex of a polymer comprising from about 25% to about 70% solids, an alcohol or other co-solvent to form a diluted latex;

b) neutralizing acid residues of the polymer which comprises said polymer to the desired level by adding dropwise an aqueous solution of base, preferably sodium hydroxide, more preferably 30% by weight sodium hydroxide;

c) adding at a rate of from 0.1% of the water which comprises the balance of the carrier to 10% of the water which comprises the balance of the carrier per minute; and

d) adding the surfactant.

Carriers and Adjunct Ingredients

The polymers which comprise the first component of the present invention are suitably dissolved in a carrier which is effective in delivering the polymer as a homogeneous layer to the flower or plant surface. Non-limiting examples of carriers according to the present invention include water and an alcohol selected from the group consisting of methanol, ethanol, isopropanol, n-propanol, ethylene glycol, propylene glycol, and mixtures thereof; preferably a carrier comprising both water and an alcohol wherein the ratio of water to said alcohol is from about 99:1 to about 1:99.

The first component of the present invention may further comprise one or more adjunct ingredients. Preferred adjunct ingredients are selected from the group consisting of surfactants, fragrance raw materials, pro-fragrances, pro-accords, dye, colorants, and mixtures thereof.

Nonionic surfactants—A preferred adjunct ingredient which comprises the first component of the present invention is one or more nonionic surfactants which do not react with the leaves or petals of the flower and form areas of “browning” which detracts from the aesthetic value of the cut flower or plant. Preferred nonionic surfactants comprise substantially linear alkyl alcohols having the formula:

ROH

wherein R is C₁₀-C₂₂ linear alkyl, and mixtures thereof; substantially linear alkoxylated alcohols having the formula:

R(EO/PO)ₘOH

wherein R is C₁₀-C₂₂ linear alkyl, and mixtures thereof; EO and PO represent ethyleneoxy units and propyleneoxy units having the formula:

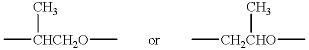

respectively, however, other alkoxy units, inter alia, 1,3-propyleneoxy, butoxy, and mixtures thereof are suitable as alkoxy units; m has an average value of from about 0.5 to about 25.

Further nonionic surfactants are mid-chain branched alkyl alcohols having the formula:

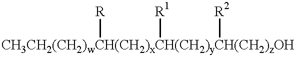

or mid-chain branched alkyl alkoxy alcohols having the formula:

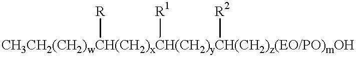

wherein the total number of carbon atoms in the branched primary alkyl moiety of these formulae (including the R, R¹, and R² branching, but not including the carbon atoms which comprise any EO/PO alkoxy moiety) is from 14 to 20, and wherein further for this surfactant mixture the average total number of carbon atoms in the branched primary alkyl moieties having the above formula is within the range of greater than 14.5 to about 17.5 (preferably from about 15 to about 17); R, R¹, and R² are each independently selected from hydrogen, C₁-C₃ alkyl, and mixtures thereof, preferably methyl; provided R, R¹, and R² are not all hydrogen and, when z is 1, at least R or R¹ is not hydrogen. M is a water soluble cation and may comprises more than one type of cation, for example, a mixture of sodium and potassium. The index w is an integer from 0 to 13; x is an integer from 0 to 13; y is an integer from 0 to 13; z is an integer of at least 1; provided w+x+y+z is from 8 to 14. EO and PO represent ethyleneoxy units and propyleneoxy units having the formula:

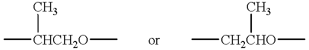

respectively, however, other alkoxy units inter alia 1,3-propyleneoxy, butoxy, and mixtures thereof are suitable as alkoxy units appended to the mid-chain branched alkyl moieties. The average value of the index m is at least about 0.01.

Examples of nonionic surfactants include Neodol® 23-6.5, Neodol® 25, Neodol® 45 ex Shell Oil Company and Pluronic® 12R3, Pluronic® 25R2 ex BASF.

The preferred surfactants of the present invention have the formula:

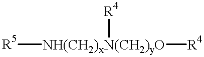

wherein R⁴ is —(CH₂)_{z}CO₂M, —(CH₂)₂SO₃M, —(CH₂)_{z}, OSO₃M, —(CH₂)_{z}PO₃M, and mixtures thereof; preferably —(CH₂)_{z}CO₂M, and mixtures thereof. The index z is from 1 to 10, preferably 2 to 4, more preferably 2 or 3. M is hydrogen or a salt forming cation, preferably sodium or potassium, more preferably sodium. The indices x and y are each independently an integer from 2 to 6; preferably 2 or 3 more preferably 2. In a preferred embodiment the indices x and y are equal to each other. R⁵ is an acyl unit having the formula:

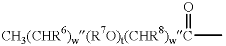

wherein R⁶ and R⁸ are each independently hydrogen, C₁-C₄ alkyl, and mixtures thereof; R⁷ is C₂-C₁₂ alkylene; t is from 0 to 10; the indices w′ and w″ are each independently from 0 to 14, w′+w″= at least 6.

Preferably R⁵ has the formula:

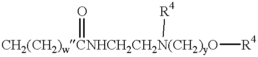

wherein R⁴ is —(CH₂)_{z}CO₂M, and mixtures thereof; the y is equal to 2 or 3; the index y is equal to the index z. The index w′ is at least 6, preferably from 8, more preferably from 10 to 14, preferably to 12.

A non-limiting example of a preferred surfactant according to the present invention is disodium lauroampho diacetate having the formula:

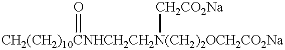

available ex Rhodia as Miranol® Ultra 32.

The surfactants suitable for use in the present invention are surfactants which do not cause browning of flower petals. A 0.01% by weight, aqueous solution of a linear alkyl benzene sulphonate (LAS) is sprayed onto a control flower. Preferably white carnations are selected as the control and test flower. The amount of flower browning which is present after 48 hours is taken as a set point. Browning of this amount will render a surfactant unsuitable for use as a surfactant according to the present invention. Preferably surfactants which provide no change in flower petal morphology or color are selected for use in the present compositions.

Second Component

The second component of the moisture transpiration control systems of the present invention is a composition which is added to water to make up a solution into which is placed the stem of a plant or flower. The water to which the second component is added can be household water, i.e. tap water, preferably said water comprises less than 3 grains of calcium, more preferably said water is distilled water, most preferably distilled water which is treated to remove any exogenic microorganisms. At a minimum, the second component of the present invention comprises a source of energy for the cut flower or plant and an effective antimicrobial as described herein below.

Source of Energy

The second component of the present invention a source of energy or nutrients for sustaining the viability cut plants or flowers during the display period. The compositions of the present invention, prior to said compositions being dissolved in water or other suitable carrier or mixtures of carriers and water, to form a solution, comprise from about 75% by weight, of a source of energy. Other embodiments of the present invention comprise from about 90% by weight, of a source of energy while yet another embodiment comprises from about 99% by weight, of a source of energy. The compositions described herein may also comprise up to about 99.95% by weight, of an energy source. Suitable sources of energy include saccharide, oligosaccharide, polysaccharide, etc., and mixtures thereof regardless of form, provided the source of energy has sufficient water solubility. For the purposes of the present invention the term “sugar” or “sugars” will stand equally well for saccharide, oligosaccharide, polysaccharide, and “reducing sugars, non-reducing sugars and the like”. Non-limiting examples of sugars, which are a source of energy, suitable for any number of embodiments of the present invention, include aldopentoses such as ribose, arabinose, and xylose; aldohexoses such as allose, altrose, glucose, mannose, gulose, idose, galactose, and talose; ketohexoses such as fructose; monosaccharide derivatives such as alkyl-α-, alkyl-β-, aryl-α-, aryl-β-glycosides such as methyl-α-D-glucopyranoside and phenyl-α-D-glucopyranoside, and salicin; disaccharides such as lactose, maltose, cellobiose, gentiobiose, turanose, isomaltose, laminaribose, melibiose, sucrose, and trehalose; and trisaccharides such as raffinose and gentianose. Examples of easily available and inexpensive source of energy include glucose and sucrose. Glucose is utilized by many of the embodiments described herein as a non-limiting example of a source of energy.

When complex sugars are taken into the plant, they are split into their constituent units, for example, sucrose into glucose and fructose, which results in a concentration gradient which further enhances the uptake of moisture.

Antimicrobial

Embodiments of the present invention include final aqueous solutions comprising from about 1 ppm (0.0001%) with upper limits of from 100 ppm (0.01%) to 200 ppm (0.02%) by weight. Indeed, other embodiments comprise from about 5 ppm (0.0005%) to to ranges of about 50 ppm (0.005%) to about 100 ppm (0.01 %) by weight, of an antimicrobial. When expressed as non-aqueous, granular compositions, or compositions prior to dissolving into a liquid carrier, comprise from about 0.1% on a dry weight basis of one or more anti-microbial compounds. Another embodiment comprising from about 1% on a dry weight basis, of one or more anti-microbial compounds.

Embodiments of the present invention include granular compositions comprising from about 100 ppm (0.01%) with upper limits of from 10,000 ppm (1%) to 20,000 ppm (2%) by weight. Indeed, other embodiments comprise from about 500 ppm (0.05%) to to ranges of about 5000 ppm (0.5%) to about 10,000 ppm (1%) by weight, of an antimicrobial. When expressed as non-aqueous, granular compositions, or compositions prior to dissolving into a liquid carrier, comprise from about 0.01% on a dry weight basis of one or more anti-microbial compounds. Another embodiment comprises from about 0.05% to about 0.1% on a dry weight basis, of one or more anti-microbial compounds.

The compositions of the present invention may also comprise antimicrobial systems which are a combination of two or more antimicrobials. Said systems will afford the formulator with the ability to target certain species of microorganisms which are characteristic of a specific plant species.

As a non-limiting example, an final aqueous solution which comprises 1% by weight, of a source of energy and 250 ppm (0.025%) of one of more anti-microbial compounds is formed from a dry (granular) composition comprising:

i) about 97.6% by weight, of a source of energy; and

ii) about 2.4% by weight, of an antimicrobial system.

One type of anti-microbial compounds are quaternary ammonium compounds having the formula:

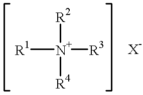

wherein R¹ and R² are each independently C₈-C₂₀ linear or branched alkyl, benzyl, and mixtures thereof, preferably R¹ and R² are each C₁₂ alkyl; or alternatively one of R¹ and R² is a mixture of n-alkyl units, inter alia, C₁₂, C₁₄, and C₁₆, and on of R¹ and R² is benzyl; R³ and R⁴ are each independently C₁-C₄ alkyl, and mixtures thereof, preferably R³ and R⁴ are each methyl; X is an anion of sufficient charge to provide electronic neutrality, preferably halogen, more preferably chlorine. Non-limiting examples of preferred antimicrobial is didodecyl dimethylammonium chloride and the admixture of C₁₂, C₁₄, and C₁₆ n-alkyl, benzyl dimethyl ammonium chlorides ex Lonza.

Another type of antimicrobial includes isothiazolones having the formula:

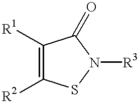

wherein R¹ and R² are each independently hydrogen, alkyl, alkenyl, halogen, cyano, and mixtures thereof or R¹ and R² can be taken together to form an aromatic or non-aromatic, heterocyclic or non-heterocyclic ring. R³ is hydrogen, alkyl, and mixtures thereof. A preferred R³ is methyl.

Non limiting examples of suitable isothiazolones include:

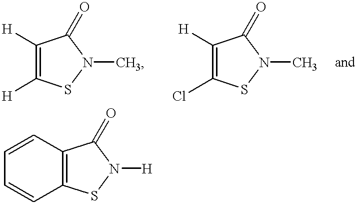

which can be combined, as in the case of Kathon® CG/ICP II ex Rohm and Haas (added embodiment) which is a combination of 2-methylisothizaol-3-one and 2-methyl-5-chloroisothizol-3-one. Another preferred anti-microbial, 1,2-benzisothiazolin-3-one, is sold under the name Proxel® GXL ex Zeneca. Anti-microbial of this class can be used at a level of from about 0.1 ppm (0.00001%), in other embodiments from about 1 ppm (0.0001%). The upper range of antimicrobials can be up to about 20 ppm (0.002%), yet other embodiments may limit this upper range to about 10 ppm (0.001%) by weight, of the final aqueous solution which serves as the vase solution.

Buffers and Buffer Systems

The compositions of the present invention when used, have an acidic pH. What is meant herein by acidic pH is a pH which is lower than 7, or which has some amount of hydrogen ion present. Particularly useful embodiments have a pH of between 2 and about 5. Some embodiments are more narrow in range, that is from about about 3 to about 4 or from about 2 to about 3.5. The final pH range will be predicated on several factors including the selection of buffers or buffer systems, the type of embodiment and the scope of the formulators composition.

The aqueous compositions of the present invention comprise in one embodiment from about 0.0001% (1 ppm) by weight, of said buffer. Other embodiments comprise from 0.001% (10 ppm) to about 0.1% (1000 ppm) by weight, of said buffer. A particular embodiment comprises from about 0.01% (100 ppm) to about 0.016% (160 ppm) by weight, of a buffer system.

For dry granular compositions which are to be dissolved in a suitable carrier, on embodiment comprises from about 0.98% by weight, of a buffer. Other embodiments comprise from 2% to about 10% by weight, of a buffer. A particular embodiment comprises from 1.5 to 2% by weight, of said buffer.

Organic acid buffers and buffering systems may be used by the formulator as well as buffers and buffering systems which derive from inorganic acids. For example, citric acid may be used directly as a buffer, or in another embodiment, a citric acid/sodium citrate admixture may be used to create specific system. Sodium hydrogen phosphate/disodium hydrogen phosphate buffer systems are also suitable for the present invention.

Non-limiting examples of suitable acids include those selected from the group consisting of citric acid, itaconic acid, malonic acid, maleic acid, caffeic acid, succinic acid, adipic acid, sebacic acid, and salts thereof. Of course, the free acid and salts may be added as admixtures and admixtures of any acids and acid salts can be employed.

Adjunct Ingredients

The polymers which comprise the first component of the present invention are suitably dissolved in a carrier which is effective in delivering the polymer as a homogeneous layer to the flower or plant surface. Non-limiting examples of carriers according to the present invention include water and an alcohol selected from the group consisting of methanol, ethanol, isopropanol, n-propanol, ethylene glycol, propylene glycol, and mixtures thereof; preferably a carrier comprising both water and an alcohol wherein the ratio of water to said alcohol is from about 99:1 to about 1:99.

The first component of the present invention may further comprise one or more adjunct ingredients. Preferred adjunct ingredients are selected from the group consisting of surfactants, fragrance raw materials, pro-fragrances, pro-accords, dye, colorants, and mixtures thereof. Suitable pro-fragrances and pro-accords are described in U.S. Pat. No. 5,919,752 Morelli et al., issued Jul. 6, 1999; U.S. Pat. No. 5,756,827 Sivik, issued May 26, 1998; U.S. Pat. No. 5,744,435 Hartman et al., issued Apr. 25, 1998; and U.S. Pat. No. 5,965,767 Sivik et al., issued Oct. 12, 1999 all of which are incorporated herein by reference.

The compositions of the present invention are not restricted to preserving cut flowers and plants but are also useful in extending the life of harvested fir trees, inter alia, for use as Christmas trees, or the cuttings taken from branches for use as adornment. Coniferous trees, typically, firs which are placed in the home as adornments during Christmas are subject to dehydration and are, therefore, prone to dropping their needles and becoming a fire hazard. The compositions of the present invention can be used to extend the life of fir trees which are harvested for holiday decorations. Palm fronds as well as ferns may also have their aesthetic life extended by the compositions of the present invention.

In the first aspect of the present invention, the formulations of the second component are prepared as dry, powdered mixtures which are stored and shipped as such and dissolved in water immediately prior to use as cut flower preservative solutions. When in the form of dry powders, the formulations of this invention are packaged in bulk for end use, as in containers having a tightly-fitting lid such as screw-capped or snap-capped bottles or, preferably are packaged in plastic or foil packets containing the required amount of material for a single use. In one aspect of the present invention, the compositions are prepared as dry, powdered mixtures which are stored and shipped as such and dissolved in water immediately prior to use as cut flower preservative solutions. When in the form of dry powders, the formulations of this invention are packaged in bulk for end use, as in containers having a tightly-fitting lid such as screw-capped or snap-capped bottles or, preferably are packaged in plastic or foil packets containing the required amount of material for a single use.

A dry composition comprising 99.5% by weight, sucrose and the balance an anti-microbial, when 1 gm of said dry composition is dissolved in 1 liter of distilled water will provide approximately 0.1% by weight, of a source of energy and approximately 5 ppm of said anti-microbial. The formulations of the compositions, depending upon the relative levels of components, are dissolved in water just prior to use at a concentration ranging from about 1 g/liter, preferably from about 5 g/liter, more preferably from about 7 g/liter to about 20 g/liter, preferably about 15 g/liter, more preferably to about 10 g/liter. For a typical arrangement of cut flowers, the volume of water in a vase is about one-half to one liter. Therefore, a preferred package of the second component of the present invention is a foil or plastic packet containing about 2.5 grams to 3 grams of material.

In another embodiment of the present invention, the source of water can be critical. For example, certain regions have native water, household or otherwise, which contains high levels of calcium. Therefore the compositions may be delivered as a concentrate in de-ionized, distilled water which when added to a native water supply provides a solution having a sufficiently low level of calcium to establish post-harvest plant viability. Alternatively, the compositions can be delivered as a final solution in non-calcium containing water.

Flowers are ubiquitous because they are opportunistic and adaptive. Flowers are found on all habitable continents and have a variety of forms. Because of a need to adapt to particular growing niches, inter alia, short moisture cycles, lack of sufficient or arable soil, flowers have developed various life cycles. For example, some flowers produce one flower and then die (tulips, narcissus) while others continue to produce blossoms throughout the growth season (roses). The means by which plants regulate senescence is also variable. Certain plants, once they sense their pollen has been sufficiently transferred will begin focusing their energy on seed production and begin to drop their petals. This signal can be sent in various ways, inter alia, the movement caused by moderate, gusty wind or by the contact of an animal with the blossom. In another case, the act of breaking, pinching, or cutting a flower will bring about the rapid demise of the flower portion.

With these considerations in mind, the formulator may wish to apply the first component of the present invention to a flower prior to harvesting of the blossom. The formulator may select the type of polymer to be applied based upon both the conditions described herein above, as well as, the transport conditions from the growing beds, or upon the means of harvesting the flowers. In one aspect of the present invention, flowers which are treated with a first component of the present invention may be transported solely in water which does not contain the second component. The present invention allows the formulator to adjust the properties of the first component to delay the exposure of the cut flowers to the second component. This can be done by adjusting the water vapor transfer rate of the polymer. Also the amount of polymer, i.e., the thickness of the polymer film can be adjusted to allow for a modified level of water vapor transpiration.

The following are non-liming examples of the systems which comprise the present invention.

TABLE I

| | weight % | | | |
|---|---|---|---|---|
| Ingredients | 1 | 2 | 3 | 4 |
| First Component (SPRAY) | | | | |
| Copolymer¹ | 2.5 | — | — | — |
| Copolymer² | — | 2.2 | — | — |
| Copolymer³ | — | — | 2.9 | — |
| Copolymer⁴ | — | — | — | 1.8 |
| Surfactant⁵ | 0.1 | 0.1 | 0.1 | 0.1 |
| Carrier⁶ | balance | balance | balance | balance |
| Percent acid residues neutralized | 10 | 10 | 10 | 12 |
| Second Component (VASE) | | | | |
| Source of energy⁷ | 1.0 | 1.0 | — | — |
| Source of energy⁸ | — | — | 1.5 | — |
| Source of energy⁹ | — | — | — | 1.25 |
| Antimicrobial¹⁰ | 0.01 | 0.01 | 0.025 | 0.025 |
| Antimicrobial¹¹ | 0.01 | 0.01 | — | — |
| Antimicrobial¹² | 0.005 | 0.005 | — | — |
| Calcium sequestrant¹³ | | 1.0 | — | 1.0 |
| Carrier¹⁴ | balance | balance | balance | balance |

```
¹Reaction product of:
  i) about 43% by weight, of methyl methacrylate;
  ii) about 47% by weight, of butyl acrylate; and
  iii) about 10% by weight, of acrylic acid.
²Reaction product of:
  i) about 40% by weight, of methyl methacrylate;
  ii) about 47% by weight, of butyl acrylate; and
  iii) about 13% by weight, of acrylic acid.
³Reaction product of:
  i) about 43% by weight, of methyl methacrylate;
  ii) about 45% by weight, of butyl acrylate; and
  iii) about 12% by weight, of acrylic acid.
⁴Reaction product of:
  i) about 43% by weight, of methyl methacrylate;
  ii) about 43% by weight, of butyl acrylate; and
  iii) about 14% by weight, of acrylic acid.
⁵Disodium lauroampho diacetate available ex Rhodia as Miranol ® Ultra 32.
⁶80% distilled water, 20% SD-3A alcohol ex J. T. Baker.
⁷Sucrose.
⁸Glucose.
⁹Isomaltose.
¹⁰Didodecyl dimethylammonium chloride.
¹¹Admixture of C₁₂, C₁₄, and C₁₆ n-alkyl, benzyl dimethyl ammonium chlorides ex Lonza.
¹²1,2-Benzisothiazolin-3-one sold under the name Proxel ® GXL ex Zeneca.
¹³Sodium tripolyphosphate.
¹⁴Distilled water.
```

What is claimed is:

1. A system for controlling plant and flower moisture transpiration, said system comprising:
a) a first component in the form of a solution, said solution applied to the surface of a plant or flower exposed to air, said first component comprising:
i) a polymer having a water vapor transfer rate of less than 10 g-mm/m²-day and a glass transition temperature, T_{g}, greater than about 30° C;
ii) the balance carriers and adjunct ingredients;
wherein said polymer is in the form of a microemulsion having a particle size less than 400 nanometers; and
b) a second component comprising:
i) a source of energy for the plant or flower being treated;
ii) an antimicrobial;
wherein said second component is dissolved in water to form a solution and into which solution is placed the plant or flower to be preserved.

2. A system according to claim 1 wherein said microemulsion has a particle size less than 200 nanometers.

3. A system according to claim 2 wherein said microemulsion has a particle size less than 100 nanometers.

4. A system according to claim 1 wherein said polymer has a water vapor transfer rate of less than 7 g-mm/m²-day.

5. A system according to claim 4 wherein said polymer has a water vapor transfer rate of less than 5 g-mm/m²-day.

6. A system according to claim 1 wherein said polymer has a glass transition temperature, T_{g}, greater than about 35° C.

7. A system according to claim 6 wherein said polymer has a glass transition temperature, T_{g}, greater than about 40° C.

8. A system according to claim 1 wherein said first component carrier comprises water and an alcohol selected from the group consisting of methanol, ethanol, isopropanol, n-propanol, ethylene glycol, propylene glycol, and mixtures thereof; wherein the ratio of water to said alcohol is from about 99:1 to about 1:99.

9. A system according to claim 1 wherein said first component adjunct ingredients are selected from the group consisting of fragrance raw materials, pro-fragrances, pro-accords, dye, colorants, and mixtures thereof.

10. A system according to claim 1 wherein said second component source of energy is selected from the group consisting of one or more carbohydrates, plant or flower digestible polysaccharides, and mixtures thereof.

11. A system according to claim 1 wherein said antimicrobial has the formula: 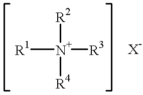
wherein R¹ and R² are each independently C₈-C₂₀ linear or branched alkyl, benzyl, and mixtures thereof; R³ and R⁴ are each independently C₁-C₄ alkyl, and mixtures thereof; X is an anion of sufficient charge to provide electronic neutrality.

12. A system according to claim 11 wherein R¹ and R² are each C₁₂ alkyl; R³ and R⁴ are each methyl; X is chlorine.

13. A system according to claim 1 wherein said second component further comprises a calcium ion sequestrant.

14. A system for controlling plant and flower moisture transpiration, said system comprising:
a) a first component in the form of a solution, said solution applied to the surface of a plant or flower exposed to air, said first component comprising:
i) from about 0.01% to about 20% by weight, of a polymer such that the water vapor transfer rate and glass transition temperature, T_{g}, of said polymer define a point to the left of a line having the equation:
y=−0.068443×+10
wherein the ordinate, x, is the glass transition temperature and the abscissa, y, is the water vapor transfer rate of said polymer;
ii) the balance carriers and adjunct ingredients; and
b) a second component comprising:
i) a source of energy for the plant or flower being treated;
ii) an antimicrobial;
wherein said second component is dissolved in water to form a solution and into which solution is placed the plant or flower to be preserved.

15. A system according to claim 14 wherein said polymer comprises the reaction products of mono-carboxylic acids and the esters, amides, and anhydrides thereof comprising one olefin moiety.

16. A system according to claim 15 wherein said mono-carboxylic acids are selected from the group consisting of acrylic acid, methacrylic acid, crotonic acid, and mixtures thereof.

17. A system according to claim 14 wherein said esters of mono-carboxylic acids are selected from the group consisting of n-propyl methacrylate, n-butyl methacrylate, methyl methacrylate, n-butyl acrylate, 2-(N,N-dimethylamino)ethyl methacrylate, and mixtures thereof.

18. A system according to claim 14 wherein said polymer comprises the reaction products of mono-carboxylic acids and the esters, amides, and anhydrides thereof comprising one olefin moiety, polycarboxylic acids and the esters, amides, and anhydrides thereof comprising one olefin moiety.

19. A system according to claim 18 wherein said polycarboxylic acids are selected from the group consisting of oxalic acid, succinic acid, tartaric acid, itaconic acid, maleic acid, and mixtures thereof; and the esters, amides, and anhydrides thereof.

20. A system according to claim 14 wherein said solution of said polymer of component one forms a microemulsion having a particle size less than 400 nanometers.

21. A system according to claim 20 wherein said solution of said polymer of component one forms a microemulsion having a particle size less than 200 nanometers.

22. A system according to claim 21 wherein said solution of said polymer of component one forms a microemulsion having a particle size less than 100 nanometers.

23. A system according to claim 14 wherein said first component carrier comprises water and an alcohol selected from the group consisting of methanol, ethanol, isopropanol, n-propanol, ethylene glycol, propylene glycol, and mixtures thereof; wherein the ratio of water to said alcohol is from about 99:1 to about 1:99.

24. A system according to claim 14 wherein said first component adjunct ingredients are selected from the group consisting of fragrance raw materials, pro-fragrances, pro-accords, dye, colorants, and mixtures thereof.

25. A system according to claim 14 wherein said second component source of energy is selected from the group consisting of one or more carbohydrates, plant or flower digestible polysaccharides, and mixtures thereof.

26. A system according to claim 14 wherein said antimicrobial has the formula: 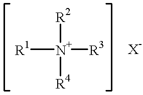
wherein R¹ and R² are each independently C₈-C₂₀ linear or branched alkyl, benzyl, and mixtures thereof; R³ and R⁴ are each independently C₁-C₄ alkyl, and mixtures thereof; X is an anion of sufficient charge to provide electronic neutrality.

27. A system according to claim 26 wherein R¹ and R² are each C₁₂ alkyl; R³ and R⁴ are each methyl; X is chlorine.

28. A system according to claim 14 wherein said second component further comprises a calcium ion sequestrant.
